(19) United States
(12) Patent Application Publication
(10) Pub. No.: US 2004/0103199 A1
(43) Pub. Date: May 27, 2004

(54) Method and system for client browser update from a lite cache

(76) Inventors: Anthony Chao, Long Island City, NY (US); Mark Graham, Scarsdale, NY (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/065,817

(22) Filed: Nov. 22, 2002

(51) Int. Cl. G06F 15/16; G06F 17/30; G06F 7/00

(52) U.S. Cl. 709/228; 709/218; 707/10

(57) ABSTRACT

A method and system for data cache with browser notification of a change in the cache and update of the browser information content from the cache. A subset of data in a larger SQL type database, in the form of a lite cache is extracted and stored in RAM. The lite cache includes a record ID and one variable, although the SQL type database typically includes a plurality of variables associated with the record ID. The lite cache is updated on a periodic basis from the SQL type database. A client browser establishes an HTTP connection with a server and loads a web page with information content including content from the lite cache. The server and client also establish a TCP socket connection to pass messages from the server to the client over the socket connection. When the lite cache is updated and it is determined that browser content from the lite cache needs update or has changed, the application server triggers transmission of a change notice message over the socket connection. Upon browser receipt of the change notice message, the browser initiates a refresh of the information content over the HTTP connection.

### BACKGROUND OF INVENTION

1. Field of the Invention

The present invention relates to multi-computer network interaction, and more particularly to networked client-server architectures.

2. Description of the Related Art

In client-server computing and enterprise architectures, data caching is known. What is needed is a method and system to provide data cache of information that is routinely required, periodically refreshing the data cache and providing browser content refresh that is based on change of the cache data, rather than an arbitrary browser refresh cycle such as time.

The preceding description is not to be construed as an admission that any of the description is prior art relative to the present invention.

### SUMMARY OF INVENTION

In one embodiment, the invention provides a method and system for updating information on a client computer. The method and system comprising creating a data cache as a subset of a larger database; performing a periodic refresh of the data cache from the larger database; identifying change in the data cache; responsive to the change in the data cache, sending a message to the client; and responsive to the message, automatically requesting the changed data.

In one embodiment, the invention further provides a method and system for establishing a connection between the client and a server, and responsive to a request from the client to the server, sending a set of data from the data cache to the client. In one embodiment, the connection is an HTTP connection.

In one embodiment, the invention further provides a method and system for establishing a connection between the client and a server, and sending the message to the client from the server using the connection. In one embodiment, the connection is a TCP connection.

In one embodiment, the invention further provides a method and system for establishing a first connection between the client and a server; establishing a second connection between the client and the server; responsive to a request from the client to the server, sending a set of data from the data cache to the client over the first connection; sending the message to the client from the server using the second connection; and responsive to the message, automatically sending the request for the changed data from the client to the server using the first connection.

In one embodiment, the invention further provides a method and system for sending the message wherein the message has at least two states, one state indicating no change in the data cache and the other state indicating change in the data cache.

In one embodiment, the invention further provides a method and system for sending the message wherein the message is periodic. In one embodiment, the invention further provides a method and system for sending the message wherein the message is aperiodic.

In one embodiment, the invention provides a method and system for notifying a client browser of a data change in a data cache. The method and system comprising creating a data cache in a RAM cache of an application server as a subset of a larger database; establishing an HTTP connection between the client and the application server; establishing a TCP connection between the client and the application server; responsive to a resource request from the client, sending an html file via the HTTP connection to the client, the html file reflecting data in the data cache at a first time; after the first time, performing a periodic refresh of the data cache from the larger database; identifying change in the data cache; responsive to the change in the data cache, sending a message from the application server to the client via the TCP connection; and responsive to the message, sending a request for the changed data from the client to the application server via the HTTP connection.

The foregoing specific aspects of the invention are illustrative of those which can be achieved by the present invention and are not intended to be exhaustive or limiting of the possible advantages that can be realized. Thus, the aspects of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF DRAWINGS

The foregoing features and other aspects of the invention are explained in the following description taken in conjunction with the accompanying figures wherein:

FIG. 1 illustrates an overview of a system according to one embodiment of the invention;

FIG. 2 illustrates interactions of elements of a system according to one embodiment of the invention;

FIG. 3 illustrates steps in a method according to one embodiment of the invention;

FIG. 4 illustrates steps in a method according to one embodiment of the invention;

FIG. 5 illustrates steps in a method according to one embodiment of the invention;

FIG. 6 illustrates steps in a method according to one embodiment of the invention;

FIG. 7 illustrates steps in a method according to one embodiment of the invention;

FIG. 8 illustrates steps in a method according to one embodiment of the invention;

FIG. 9 illustrates steps in a method according to one embodiment of the invention;

FIG. 10 illustrates steps in a method according to one embodiment of the invention;

FIG. 11 illustrates steps in a method according to one embodiment of the invention;

FIG. 12 illustrates steps in a method according to one embodiment of the invention;

FIG. 13 illustrates interactions of various aspects of the invention; and

FIG. 14 illustrates interactions of various aspects of the invention.

It is understood that the drawings are for illustration only and are not limiting.

### DETAILED DESCRIPTION

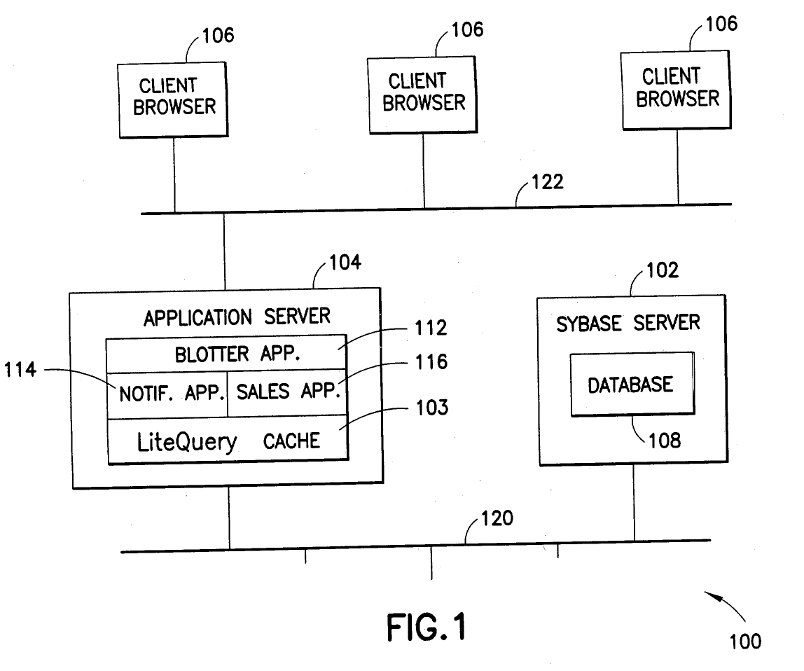

Referring to FIG. 1, an embodiment of system 100 of the invention includes a Sybase server 102 connected to application server 104 by network 120. LiteQuery cache 103 is part of application server 104 and is also connected to Sybase server 102 by network 120. Client 106 with a browser application is connected to application server 104 and LiteQuery cache 103 by network 122. In one embodiment, network 122 is the Internet. Network 120 may also be the Internet, or it may be a private network, such as a LAN or WAN. Although not illustrated in the figure, it is possible for Sybase server 102 to be connected to client 106 by network 122. However, for security and interoperability reasons, it is more common for client browser 106 to have access to Sybase server 102 only thru application server 104. Sybase server 102 may include multiple programs or applications, such as Sybase database 108. Application server 104 also may include multiple programs, such as trading applications 112, 116 and notification application 114.

Throughout the embodiments described herein, server 102 is referred to as Sybase server 102. Sybase is a particular server brand, available from Sybase Inc. of Berkeley Calif., and there is nothing particularly unique about a Sybase server that limits server 102 to only a Sybase server.

For many businesses and organizations, a large portion of their information processing and management, which is integral to their day-to-day operations, uses web-based application components. For these businesses and organizations, providing uniform standards and services for those web-based application components is very important. Uniform standards and services allow application developers to focus on development, deployment and maintenance of applications without re-creating common components that are frequently used by other applications. Uniform standards and services also provide a more consistent user interface for the various web-based applications.

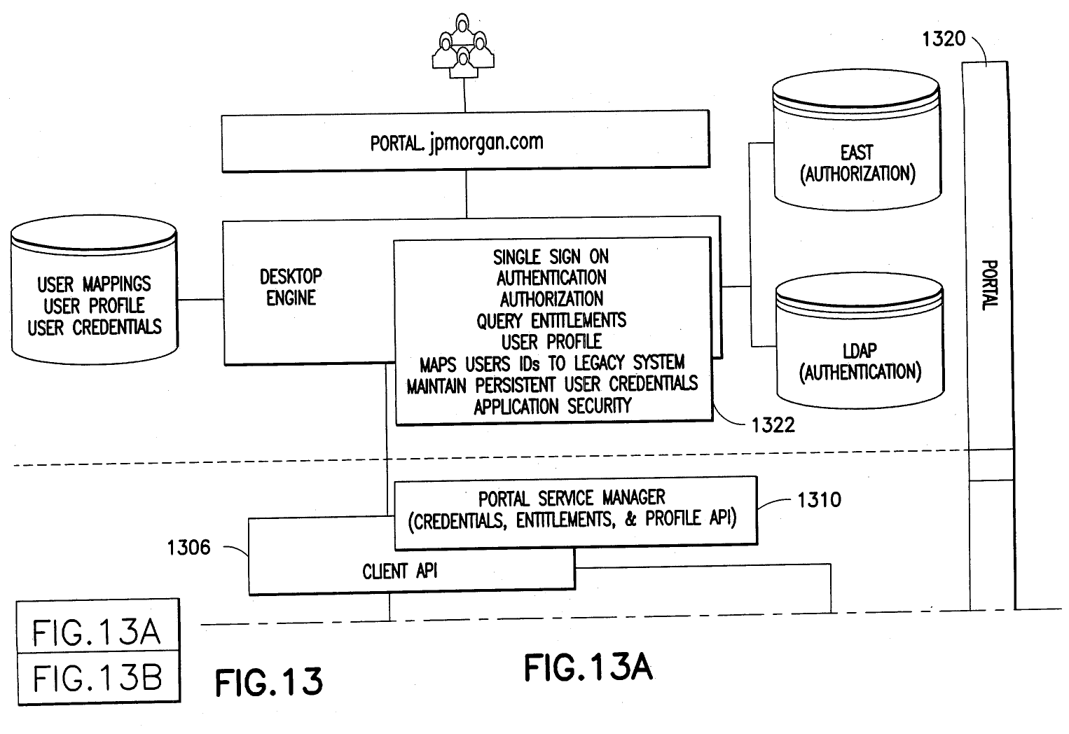

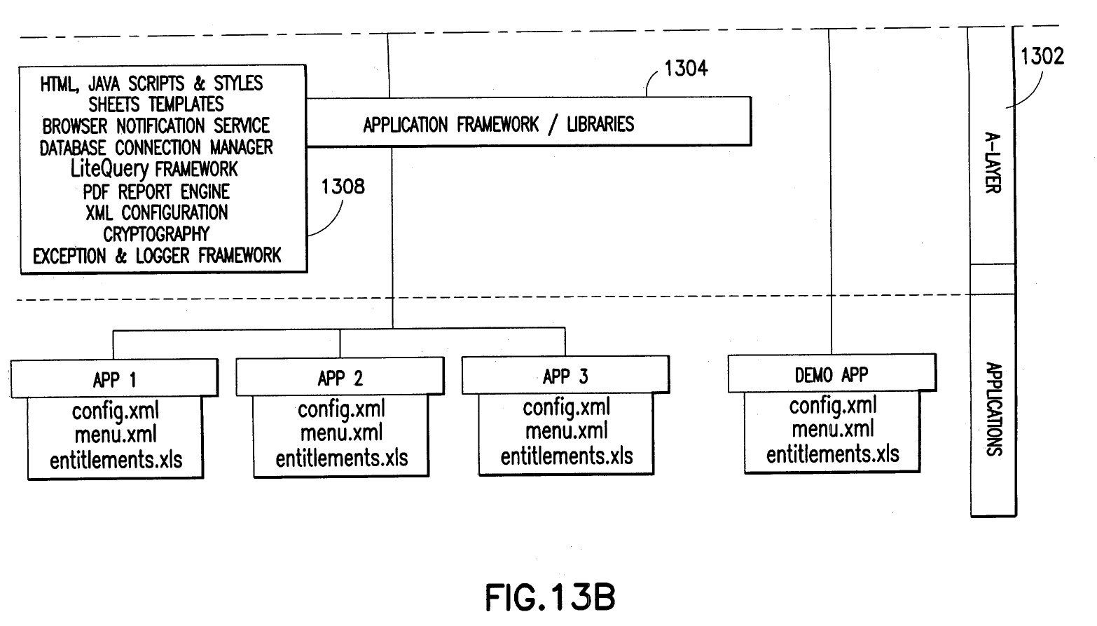

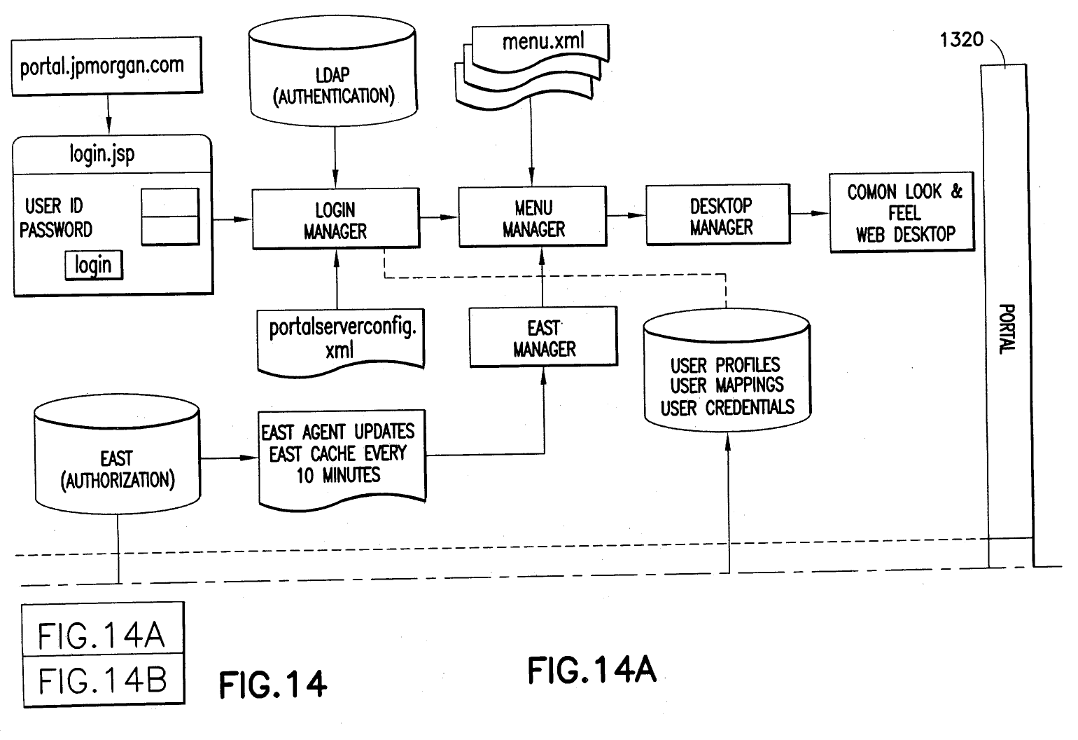

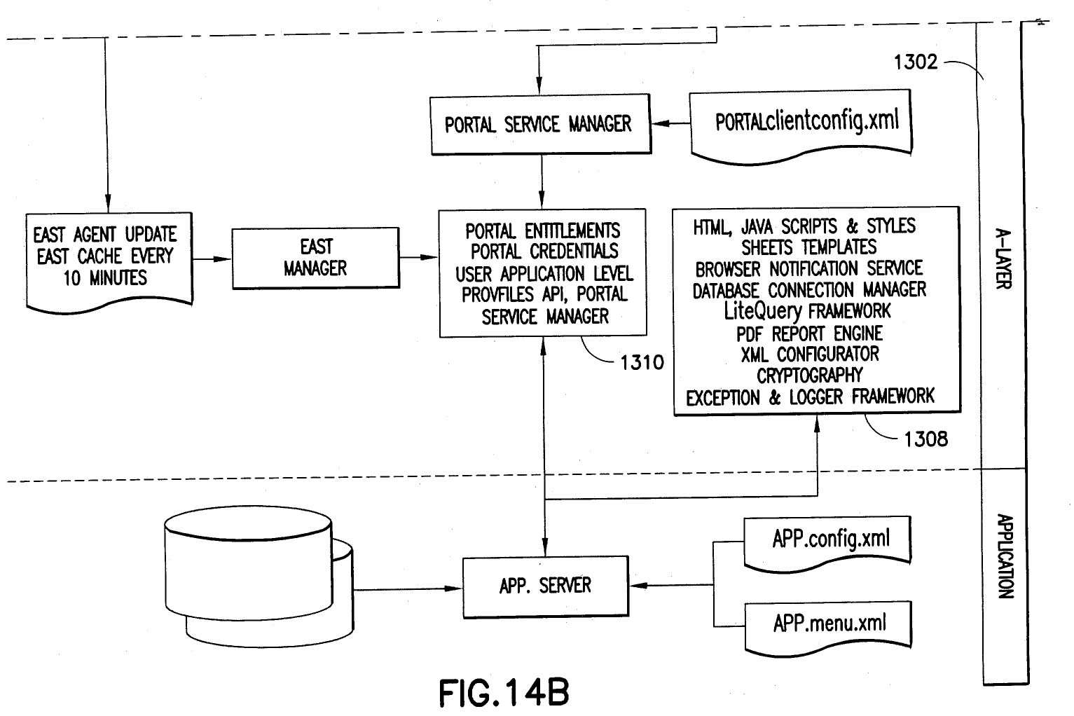

The following is an overview and description of two major architectural components that encompass aspects of the invention. These two major architectural components (A-LAYER and PORTAL) are illustrated in FIGS. 13 and 14 and described below. As an example, the description below uses a trading environment. However, there is no requirement that the embodiments only apply in a trading environment. It should also be noted that although the various embodiments are described and illustrated in the context of an enterprise architecture, there is nothing that requires an enterprise architecture.

I. Architectural Layer (“A-LAYER”) A-LAYER (1302) contains two main components: an Application Framework (“FRAMEWORK”) (1304) and a Client API (1306).

A. FRAMEWORK The Application Framework (1304) is a group of ten services and standards (1308) to help develop applications that a user can launch from PORTAL. These services and standards are: (1) HTML Templates; (2) JavaScript Templates/Libraries, (3) Cascading Style Sheets; (4) Browser Notification Service; (5) Database Connection Manager; (6) LiteQuery Framework; (7) PDF Report Engine; (8) XML Configurator; (9) Cryptography; and (10) Exception & Logger Framework.

(1) HTML Templates Realizing that many applications will utilize the same types of screens (search, deal entry, blotter), a set of HTML templates are assembled. These templates contain all formatting and setup for standard screen types. This includes the use of JavaScript functions, Style Sheets as well as the general layout. By using the HTML templates, an application developer can maintain the same look and feel across applications.

(2) JavaScript Templates/Libraries javaScript is used extensively throughout the applications that use PORTAL. In order to assist rapid application development and standardize re-usable code, a javaScript Library is established containing a standard set of JavaScript Functions. The library includes, but is not limited to, functions that perform the following: (i) Layer creation; (ii) Launching Pop-Up Windows; (iii) Date formatting depending on location; (iv) Menu creation; (v) Form submission for hidden JSPs; (vi) Shortcuts for data entry; (vii) Rounding; (viii) List box for options; (ix) Row Selection; and (x) Auto-completion in entry fields using data sets in hidden JSPs. In order to assist in standardizing code layout, templates are also available for writing functions that are more specific to a given application.

(3) Cascading Style Sheets To standardize the look and feel for all applications that are launched through PORTAL, FRAMEWORK provides a common Cascading Style Sheet (“CSS”) file that all applications can call. PORTAL implements the use of CSS 2.0. Examples of the types of tags that are included in the PORTAL CSS, include but are not limited to, tables, backgrounds, font sizes, and types, alternating rows, negative and positive numeric formatting and alignment.

(4) Database Connection Manager The A-LAYER connection manager is used by applications to connect to application databases. It uses the PORTAL framework to retrieve database specific user id's mapped to single sign-on user id. The Connection Manager queries the PORTAL user ID mapping Database to acquire database id's.

The A-LAYER connection manager is available for use in two forms. In situations where a specific database connection needs to be established under a specific user's name, a dedicated connection is associated to the user. The same connection is used for that user until the session expires.

The second form of A-LAYER connection manager supports a connection pooling methodology. The server creates a group of connections, which are available upon request. These connections are reusable among all authorized users. A typical example could be a reporting tool wherein the application does not demand specific database user id's to connect to the database.

The connection manager will automatically expire, or time-out, connections that have been unused for a specific period of time. The time limit is a configurable variable. It does this by starting up a “connection vulture” to periodically examine each connection that the connection manager monitors, and disconnect those connections that have been unused for a specified amount of time, or have been open for longer than the configured limit.

Where an application is not required to stamp a transaction or request with a specific user id for auditing purposes, the connection pooling method is recommended. One reason is that database connections are an expensive overhead and may result in reducing server performance.

(5) Browser Notification Service One objective of the Browser Notification Service is to keep viewed data on the client as up to date as possible. A second objective is to keep the implementation as simple as possible.

For each LiteQuery cache notification to be handled, the application server creates at least one Java bean. The bean registers itself with the LiteQuery cache, specifying a callback method for the desired notification. When notified, the callback method retrieves the parameters and, in turn, passes them to a stored procedure to fetch the updated data. The updated data is then stored in a vector in the bean along with a timestamp. This data remains alive in the vector for a period of time, such as five minutes. The vector is periodically examined inside a thread, such as every minute. Any data older than the specified time is deleted. (Note that Vector has synchronized methods.)

From the client, an applet in a hidden frame establishes a socket connection with a notifier object in the application server. This notifier object in the application server sends out a heartbeat every ten seconds in the form of a string message (“heartbeat”). When the data in the cache changes, the notification bean in application server 104 informs the notifier object that it has received a change or update notification; this causes the notifier object in the application server to change (“refresh”) the text of the heartbeat message. Client javaScript continuously monitors the text of the heartbeat message. When the client JavaScript determines that the heartbeat message has changed, it triggers another hidden JSP within the client to call application server 104 or LiteQuery cache 103 to fetch the vector of notifications. Other client javaScript functions then update the user's view of the data.

Three classes are implemented for Notification. They are a factory for creating a notification manager, the notification manager itself, and an abstract class that all notification beans should subclass from. Any application developer that wants to add a notification bean need only extend the abstract class and implement three methods. An application developer thus only needs to be concerned with the three methods that they have implemented.

(6) LiteQuery Framework

Background When implementing two-tier client-server systems using an object-oriented language (e.g., C++, Smalltalk or JAVA) for the client, and a relational database (e.g., Sybase or Oracle) for the server, a standard design issue is the conversion of relational data to objects (and vice-versa). The usual implementation uses a query to draw the data into the client whereupon the client can then process the result set. Each row of the result set becomes the set of values for initializing the instance variables of the newly created object.

After years of object-oriented development, this implementation has several well-known drawbacks. These drawbacks include: data traffic is typically heavy; the client requires a large amount of memory; and set up times can be long.

In designing the LiteQuery Framework it was noted that stored procedures in legacy databases return more data than the view (as in Model-View-Controller) typically requires. This in turn results in full-blown, “heavy” objects that quickly eat up client memory. Finally, as business grows from several hundred assets and counterparties to thousands, initializing thousands of asset and counterparty objects requires long set up times.

LiteQuery Basic Design The LiteQuery is designed to be used by multi-tier applications that employ HTML/JSPs, servlets, and application server and legacy database technologies. One design objective is to eliminate the three problems mentioned above. In one embodiment, the LiteQuery cache acts as a “client” to the legacy database server. It is recognized that the view, typically a trade entry screen or a search screen written as HTML/JSP, requires only two entities: a display string and a key.

Considering the case when a user enters a trade and the user selects an asset or counterparty. The typical user, when selecting an asset or counterparty, is only interested in the name of the asset or the counterparty. The view therefore requires only a display string. When saving the trade, the application requires a unique identifier for the asset or counterparty, typically the database primary key.

This is ideal for HTML/JSPs since the display string is what is presented to the user, and the key is the value that is passed to the servlet for processing.

Recognizing this, in one embodiment, A-LAYER implements a LiteQuery Framework. When queried, the LiteQuery Framework returns the display string and key. If more complete information is required for an asset or counterparty, the application server or LiteQuery cache requests that data from the database using the primary key. This data is therefore drawn into the application only as needed.

LiteQuery Caching and Initialization The LiteQuery Basic Design that is described above significantly improves the memory requirements for assets and counterparties, and reduces the amount of data traffic. If, however, the LiteQuery Framework must go to the database each time the user requires a complete list of assets and counterparties, significant delays will be encountered. In other embodiments, the LiteQuery Framework solves this in two ways.

First, the data is cached on a LiteQuery random access memory (RAM) Cache 103 which is a part of the memory of application server 104. When a user requests a set of assets or counterparties, the query is directed first to the LiteQuery cache and not to Sybase database 102.

Second, all asset and counterparty data is initialized into the cache during the application server startup. A special servlet, the LiteQueryManagementServlet, is created for this purpose. In the initialization (inito) routine, which is called when the application server starts up, the cache is initialized. This loading process therefore never impacts the client user. When the Web server and application servers are available for client use, the cache has been initialized.

LiteQuery Cache Refresh During the period in which the application servers are up and running (which can be several days or weeks), assets or counterparties may be created or inactivated. Asset and counterparty data in cache therefore may become stale. To solve this problem, a thread is started at the time the application server is initialized that will refresh the cache. In one embodiment, this thread executes every ten minutes; this value is determined by a setting in a system configuration file (XML file). During this ten-minute period, it is possible that a user will not see a newly created counterparty or realize that a counterparty has been inactivated.

One embodiment of the invention described in greater detail below notifies the client browser of changes or updates to the LiteQuery cache shortly after a Cache refresh.

(7) PDFReport Engine The Report Engine uses the ITEXT (freeware) library as a base for creating both canned and slice and dice reports. The libraries are extended to include extra reusable functionality such as including functions for totals, truncations for numeric values as well as text values. The engine takes a data array, which is saved as a JAVA object that is returned from a stored procedure. It then uses the defined formatting and applies that to the data for presentation in a PDF file. PDF files are auto-launched from the browser and can be printed or saved from Adobe. This allows the users the ability to fax, store, or e-mail the report.

(8) XML Configurator The XML Configurator is a service that allows applications running off of PORTAL to configure their applications with information regarding where their database is located, where the application server is located, etc. Included in the Configurator are a number of JAVA classes that use the XML file to configure the application.

(9) Cryptography PORTAL offers an RSA library tailored for PORTAL applications, which allows an application developer to use 128-BIT encryption to store data. The types of data that this can be used for are the encryption of session information, and user id's that are stored in memory. This service provides a greater level of security to which only the PORTAL Cryptography Service maintains the encryption key.

(10) Exception & Logger Framework The Exception & Logger Framework provides the service of allowing a PORTAL application to store exceptions and logs in daily file sets as opposed to being overwritten on a daily basis. It is configurable to allow an application developer to decide the length of time these files will be kept before being overwritten, or discarded. It provides the application developer with the ability to archive exceptions over a longer period of time.

The Exception & Logger Framework also provides the ability to store audit and transactional history. By using the provided classes and methods, an application developer can keep track of critical events within an application as audit user specific transactions.

Certain processes or queries run as an application, as opposed to by a particular user. For these types of transactions most applications have a generic read only id that can connect to the database. PORTAL also maintains these accounts within PORTAL.

B. ClientAPI The Client API (1306) provides an interface for PORTAL Credentials, PORTAL Entitlements, User application level profiles API, and the PORTAL Service Manager (1310).

(1) PORTAL Credentials The Client API provides client Applications with the ability to pass a user's token to the API and receive back the credentials for that user as described below in Maintaining Persistent User Credentials.

(2) PORTAL Entitlements The Client API provides client applications with the ability to query user entitlements from EAST. EAST is a security framework built on IBM Policy Director and LDAP. EAST also provides information regarding PORTAL entitlements to the client applications.

(3) User application level profiles API The API for application level profiles allows an application to access user profile information saved with PORTAL. User profiles include the saving of different profiles per screen of displayed data.

(4) PORTAL Service Manager The PORTAL Service Manager is an application administrator's console that is launched from within PORTAL. The console allows an application developer or administrator to: (i) Reload their XML application configuration files; (ii) Notify and request automated upload of a new menu XML file by PORTAL; (iii) View user level entitlements to troubleshoot if users were set up correctly in the system; (iv) Check Application entitlements against EAST; (v) Check stored session information; (vi) Check to see the number of active users; and (vii) Check to see the number of users logged in but not actively using the application.

II. Web-based Applications Portal (“PORTAL”) PORTAL offers eight services (1322) that can be used by application developers to manage and deploy their applications. These services are: (1) Single Sign-On; (2) Authentication; (3) Authorization; (4) Query Entitlements; (5) User Profiles; (6) Mapping of User Ids to legacy systems; (7) Maintain Persistent User Credentials; and (8) Application Security.

(1) Single Sign-On (SSO) SSO is a security framework, which allows an application developer to add authentication (determining the identity of a user) and authorization (what is the user allowed to access) to any web based application. The concept of the single sign-on is to map several application user id's and passwords to one PORTAL user id and password. For this reason, the first time that a user signs-on to PORTAL, when they attempt to access an application, they will have to enter the user id and password for that application. On following attempts, once they have signed-in to PORTAL, they will automatically have access to the other applications that they use.

In addition, the SSO framework uses an entitlements-based approach to security. Entitlements get assigned to groups of users. Entitlements also get assigned to resources, for example JSP pages or a component of an application.

(2) Authentication Authentication is the process of uniquely identifying a user. PORTAL receives the user's credentials (evidence of identity by supplying a user id and password), validates the credentials, and returns a distinguishing unique identifier for the user (stored in the user's session information). In one embodiment, Lightweight Directory Access Protocol (“LDAP”) is used for authentication. A set of rules is defined which guides the limits on user authentication attempts, and storing of user id and passwords.

(3) Authorization/Entitlements Authorization allows a user with a defined role to access a given resource (page, user defined or application component). PORTAL uses EAST entitlements to carry out authorization. Once an application has registered it's entitlements in EAST, the application queries the PORTAL client API, and entitlement information is returned.

(4) User Profiles Because some client applications do not store any information in their legacy databases, and only make queries against the databases, PORTAL provides the ability to store user profile information in a centralized PORTAL database. Each profile is stored as a single binary record per user profile. Applications can call these profiles through the Client API layer in A-LAYER. A common JSP tag is provided though the FRAMEWORK component in A-LAYER, such that all profile management screens are the same regardless of which application is being accessed.

(5) Mapping of UserIds to Legacy Systems By providing the single sign-on ability, PORTAL also provides a database in which to store encrypted pairs of user id's and passwords for each user. Each user id and password that is stored in the database is encrypted using 128 bit-encryption using a key generated by EAST and Security Access.

(6) User Credential Persistence When a user signs-in to PORTAL, EAST returns an EAST object, which is used to check user entitlements. This EAST object is stored in a PORTAL token and passed to the browser with the following information: PORTAL ID, Session expiry time is configurable through XML, and the user's IP address. When a user first attempts to access a client application in PORTAL, the application gets the token from the user's browser with the request. The application uses this token to make a request to the PORTAL API for a credential for that user.

(7) Application Security There are certain processes or queries that are run as an application as opposed to by a particular user. For these types of transactions, most applications have a generic read only id that can connect to the database. PORTAL also maintains these accounts within PORTAL.

The two major architectural components (PORTAL & A-LAYER) are designed such that a developer deploying an application through PORTAL does not require the FRAMEWORK component of A-LAYER. Instead, they can use the Client API component of A-LAYER, and connect directly to PORTAL.

Having described the various embodiments of the invention in somewhat general detail in the context of an enterprise, a more detailed description of particular aspects of the invention is provided below.

Referring to FIGS. 1, 2 and 3, during startup of system 100, Sybase server 102, LiteQuery cache 103 and application server 104 perform various initialization steps. Many of these steps are not relevant to the invention, but some steps do have relevance to the invention and those steps are described below.

At step 308, LiteQuery cache 103 and/or application server 104 determines the data elements that should be included in the initial LiteQuery cache.

At steps 310, 312, LiteQuery cache 103 and Sybase server 102 establish a connection.

At steps 314, 316, the initial data elements for the LiteQuery cache are pulled from Sybase server 102 to LiteQuery cache 103. It is also possible that instead of being pulled, the data elements are sent from Sybase server 102 to LiteQuery cache 103.

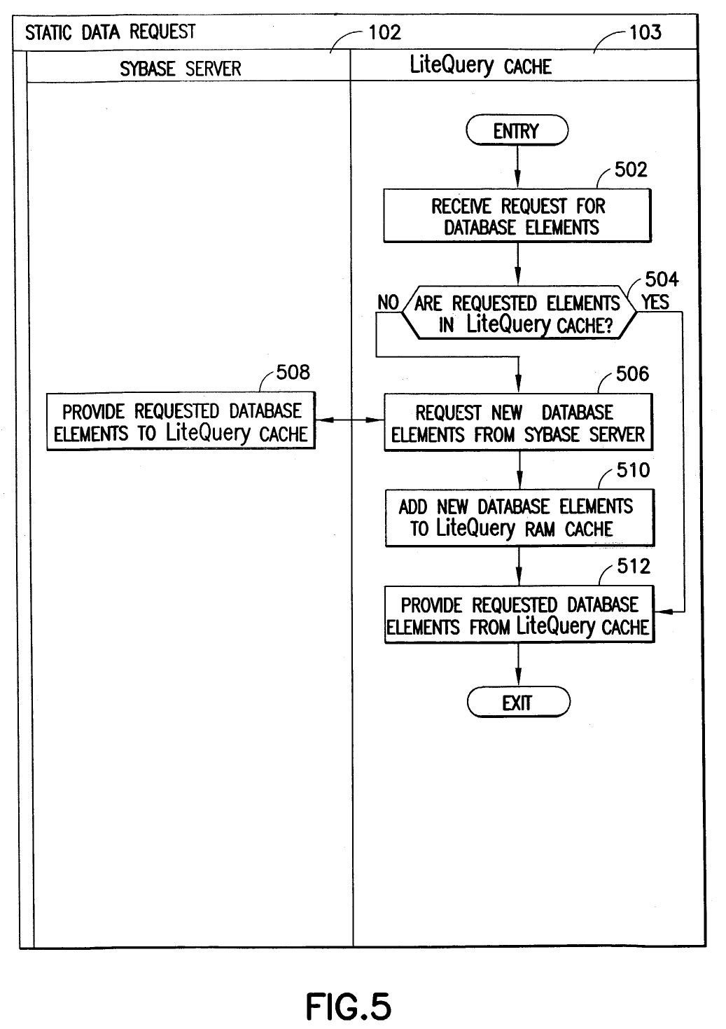

In one embodiment, upon start-up of the LiteQuery cache, only three caches are started. The caches are for assets, non-emerging market assets and counterparties. All other caches, such as countries and currencies are lazily initialized. Lazy initialize means that the cache is not initialized until a client requests information that would be in the cache. This is illustrated generally in FIG. 5. The types of data held by the LiteQuery caches are typically relatively static elements. For example, caches may be created for instruments, counterparties, and currencies. Because the data is relatively static, moment by moment synchronization between the LiteQuery cache and the underlying Sybase database is not essential. However, if the data elements in the cache are not updated or refreshed on a somewhat regular basis, the cache will become stale. For this reason, the LiteQuery cache or the application server runs a timer to periodically request and update or refresh the data elements in the cache from the Sybase server. In one embodiment, this timer/refresh cycle is a LiteQuery cache manager. This manager thread runs every 10 minutes and different caches may have different refresh cycles, some as frequently as every 10 minutes and others less frequently, such as only once a day. Each time the manager thread runs, it checks to see if any of the cache refresh cycles are due. In one embodiment, upon each refresh cycle, the entire cache is refreshed. In another embodiment, only changes to the cache are made, and the entire cache is not refreshed. Some of these aspects are not illustrated in the figures. The concept of refreshing an existing cache is different from initializing or creating a cache.

The LiteQuery cache does not include all of the elements associated with a data record type stored in the Sybase server. As an example, the data record for a particular trading party that is maintained within the Sybase server is likely to include a significant amount of information. Much of that information is needed by a client on a very infrequent basis, but the user needs some information, such as the party name for trades involving that party. Therefore, in one embodiment, the cache includes a limited subset of the full data record held by the Sybase server. The minimum information contained within the LiteQuery cache is a record ID and a string variable. The term LiteQuery cache therefore comes from the concept of using a thin cache that does not include all of the elements in the data record. The string variable and record ID from the LiteQuery cache are passed to the client browser. The string variable is displayed to the client user. The record ID is held by the browser and allows the application server and Sybase server to locate or retrieve additional information on that particular ID when or if the client user requests it. In this manner, the amount of information exchanged between the application server and the client browser is reduced. Details of this aspect of the invention are described elsewhere in greater detail.

At steps 318, 320, the notification manager of notification application 114 and LiteQuery cache 103 establish a connection. Once the connection is made, the notification manager registers with LiteQuery cache 103 for the required notifications. The notifications generally include static data types, such as instruments, counterparties, countries, and currencies with notification of add, delete and update of these data types.

At step 322, the notification manager starts three Java beans. These beans are an add bean, a delete bean and an update bean.

At step 324, the notification application 114 and/or application server 104 determines whether any client browsers 106 are connected to application server 104 and have requested notification. If no client browsers are connected or request notification, application server 104 loops or waits until there is a connection by a client browser or change notification.

At step 326, the notification manager transmits or broadcasts the heartbeat message to client browser 106. This transmission is over a TCP socket connection and is described in greater detail below.

As long as a TCP socket connection exists between application server 104 and at least one client browser 106, the heartbeat message will be broadcast to all active client browsers 106 with an active TCP socket connection. When a client browser times out or terminates their session, the TCP socket connection is lost and that client browser is removed from the list of active clients.

At step 328, the notification manager waits for a notification from LiteQuery cache 103. The notification that the notification manager waits for at step 328 is one of the notifications registered at steps 318, 320.

Referring now to FIGS. 1, 2 and 4, at step 402, application server 104 is initialized and running, with the notification application 114 generating heartbeat messages.

At step 404, client 106 loads and starts a browser application. In one embodiment, the browser is INTERNET EXPLORER, by Microsoft Corp. of Redmond Wash. In another embodiment the browser is NETSCAPE, by Netscape Communications Corp. of Mountain View Calif. Other browsers are known and appropriate for the invention.

At step 406, the user of client browser 106 logs in to the requested application server 104 and obtains browser session credentials. In one embodiment the log-in is for a single session sign-on, and the browser session credential is used with multiple applications, without the need for the user to log-in again.

At step 408, client browser 106 requests a specific application resource from application server 104 via HTTP.

At step 410, application server 104 receives the request for a resource, and begins to generate a response to the request.

At step 412, application server 104 generates content for the visible portion of the web page response, and adds this portion to the HTML response. The visible portion may include multiple layers, some of which are displayed in front of other layers. When the browser receives the HTML file, it moves various layers to the front for visibility or toward the back to make another layer visible.

At step 414, application server 104 makes a request for static data from LiteQuery cache 103. This request may include multiple steps, which are illustrated in FIG. 5 and described more fully below.

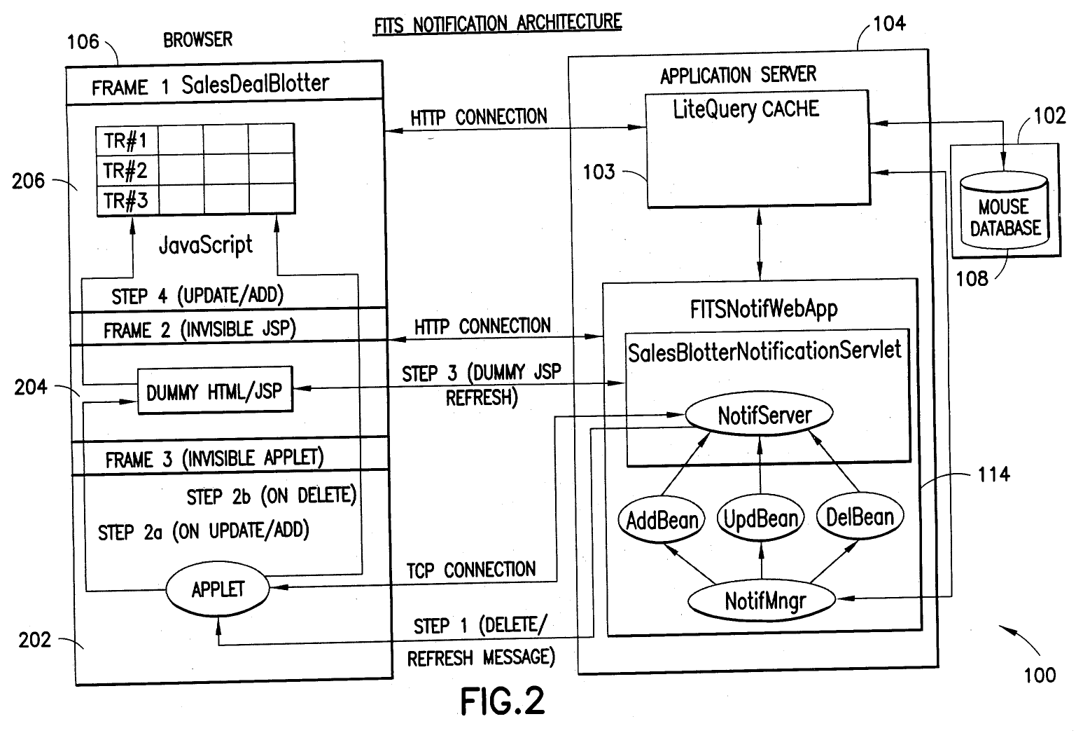

At step 416, application server 104 adds the static data content to the HTML response as dummy HTML/JSP. This static data will be included in an invisible frame (204 of FIG. 2).

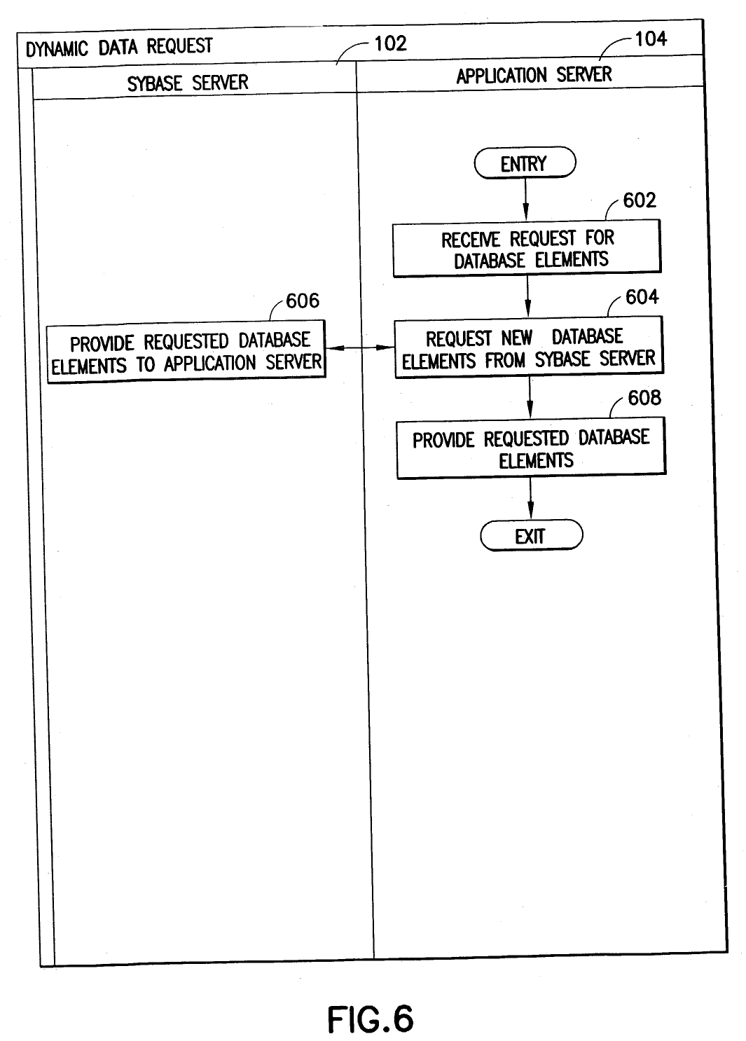

At step 418, application server 104 makes a request for dynamic data. This request may include multiple steps, which are illustrated in FIG. 6 and described more fully below.

At step 420, application server 104 adds the dynamic data content to the HTML response as dummy HTML/JSP. This dynamic data will be included in an invisible frame (202 of FIG. 2).

At steps 422, 424, application server 104 sends the HTML response to client browser 106. The HTML includes the visible content (including multiple layers) (206 of FIG. 2), and dummy HTML/JSP for invisible frames (202 and 204 of FIG. 2).

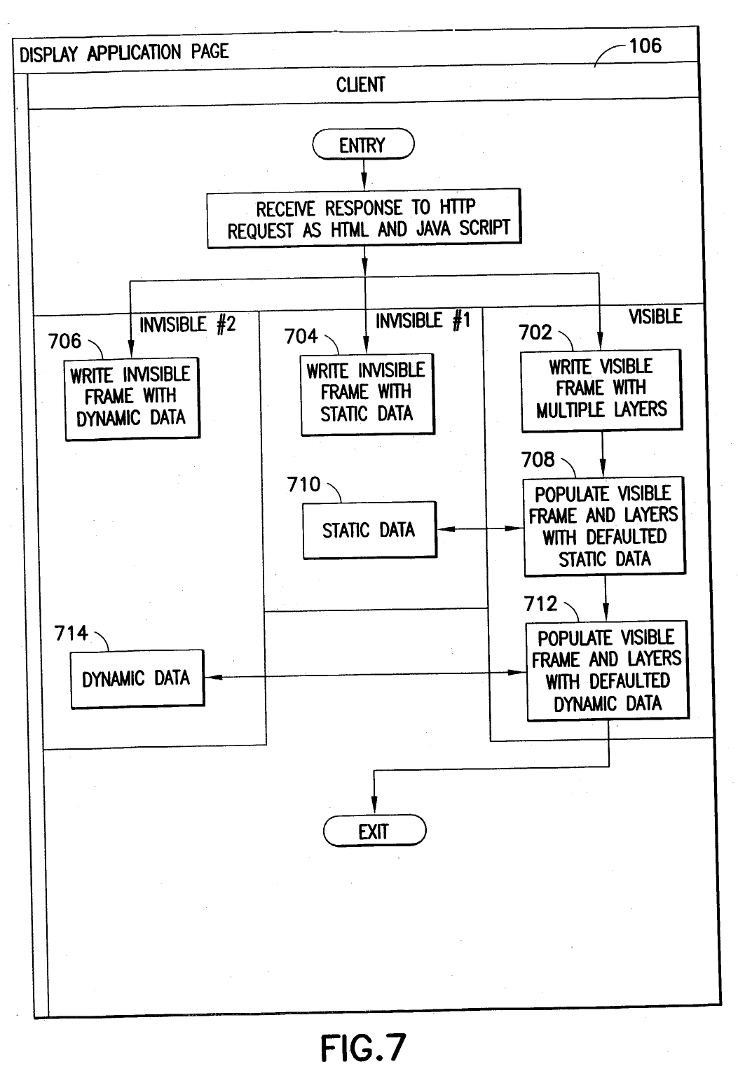

At step 426, client browser 106 reads the HTML of the response and renders the layers of the visible page content (206 of FIG. 2), as well as the invisible frames with static (204 of FIG. 2) and dynamic (202 of FIG. 2) data. Displaying the page at step 426 may include multiple steps, which are illustrated in FIG. 7 and described more fully below.

Once client browser 106 renders the initial web page at step 426, then at steps 428, 430, client browser 106 opens a TCP socket connection with the notification application 114 of application server 104. One purpose of this TCP connection is to provide a path for the heartbeat message.

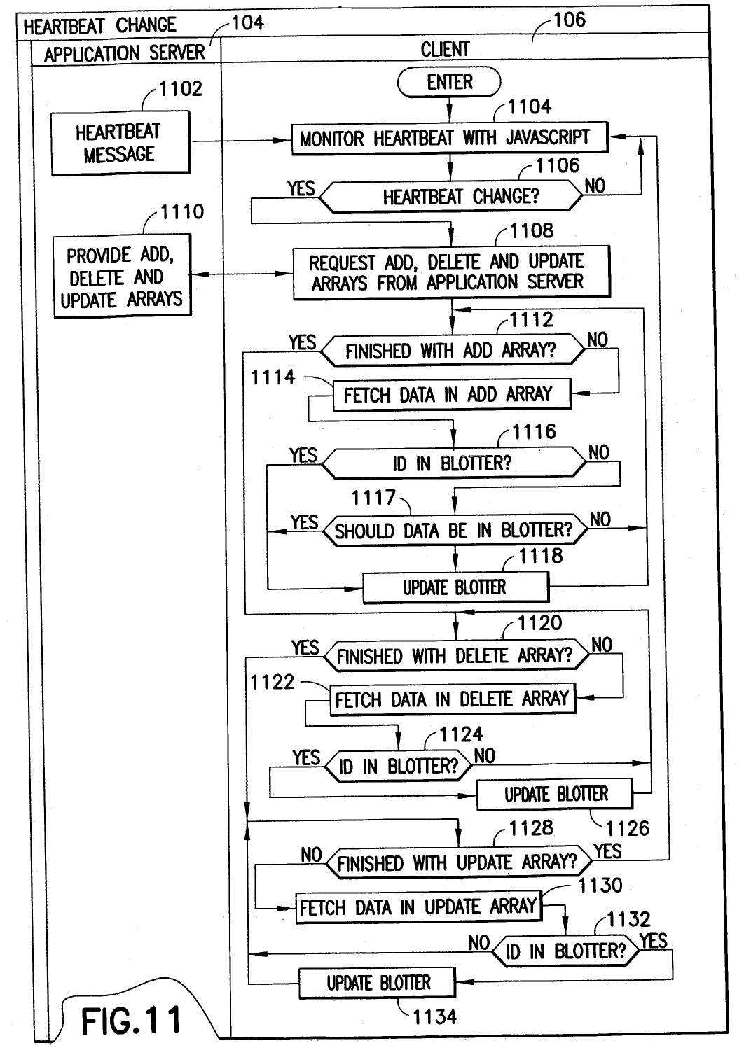

At step 432, client browser 106 monitors or waits for changes in the heartbeat message. Waiting for changes in the heartbeat message may include multiple steps, some of which are illustrated in FIG. 11 and described more fully below.

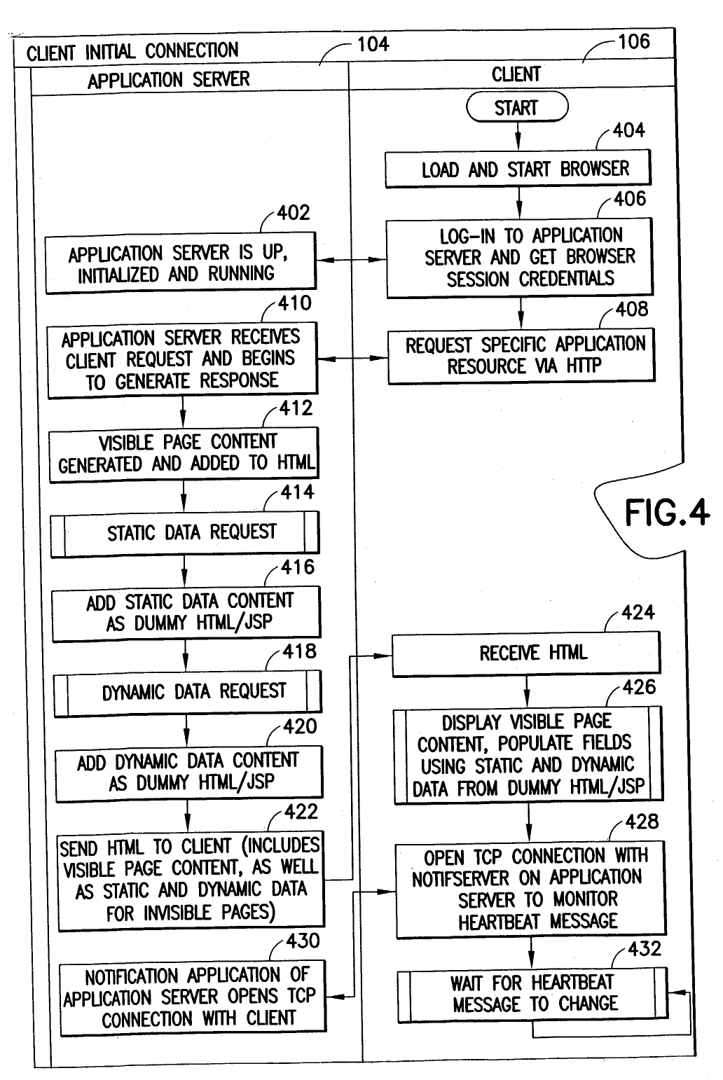

Referring now to FIG. 5, the request for static data at step 414 of FIG. 4 begins at step 502 with LiteQuery cache 103 receiving a request from application server 104 for database elements.

At step 504, LiteQuery cache 103 determines whether the requested database elements are present in the LiteQuery cache.

If the requested database elements are present in the LiteQuery cache, then at step 512, LiteQuery cache 103 provides the requested database elements from the LiteQuery cache.

If the requested database elements are not present, then at steps 506, 508, LiteQuery cache 103 requests the static database elements from Sybase server 102. This part of the lazy initialization is described elsewhere.

At step 510, LiteQuery cache 103 adds the static database elements to the LiteQuery random access memory cache.

At step 512, LiteQuery cache 103 provides the requested database elements from the LiteQuery cache.

Although the LiteQuery cache is a thin cache, it will generally include more data records than any particular client browser will use. This is because the profile of a particular user will limit the trades and deals that user has access to. For this reason, the client browser will only see some of the records held by the LiteQuery cache.

Additionally, the user of client browser 106 is normally interested in a small quantity of information from an entire data record. For example, the data record held by Sybase database 108 for a party or counterparty may include their address information, in addition to many other fields. The user of client browser 106 may be interested in only the name of the party or counterparty. Therefore, the information held by the LiteQuery cache and sent to the client browser includes only the string variable for the name, and a record ID. The party or counterparty name is displayed to the user of client browser 106, and the record ID is kept and used to uniquely identify that particular party or counterparty. The record ID allows the browser and application server to get additional information on the party or counterparty from Sybase database 108. The record ID also allows the information in a trade commit to uniquely identify the party or counterparty.

Referring now to FIG. 6, the request for dynamic data at step 418 of FIG. 4 begins at step 602 with application server 104 receiving a request for database elements.

Dynamic data is generally not stored in the LiteQuery cache, so at steps 604, 606, application server 104 requests the dynamic database elements from Sybase database 108 of Sybase server 102.

At step 608, application server 104 provides the requested dynamic database elements.

Referring now to FIG. 7, rendering the application screen at step 426 of FIG. 4 begins with client browser 106 writing a visible frame, including multiple layers (206 of FIG. 2); an invisible frame with static data (204 of FIG. 2); and an invisible frame with dynamic data (202 of FIG. 2) at steps 702, 704, 706 respectively.

Use of an invisible frame and applet (202 of FIG. 2) provides certain advantages. One advantage is that no plug-in or swing component is required, and there are no display widgets. The applet is responsible for maintaining the TCP socket connection. JavaScript monitors the instance variable to determine whether the heartbeat message has changed from “heartbeat” to “refresh.”

At steps 708, 710, the visible frame populates the fields in the various layers that require static information using the default static information that is contained within that respective invisible frame (204 of FIG. 2).

At steps 712, 714, the visible frame populates the fields in the various layers that require dynamic information using the default dynamic information that is contained within that respective invisible frame (202 of FIG. 2).

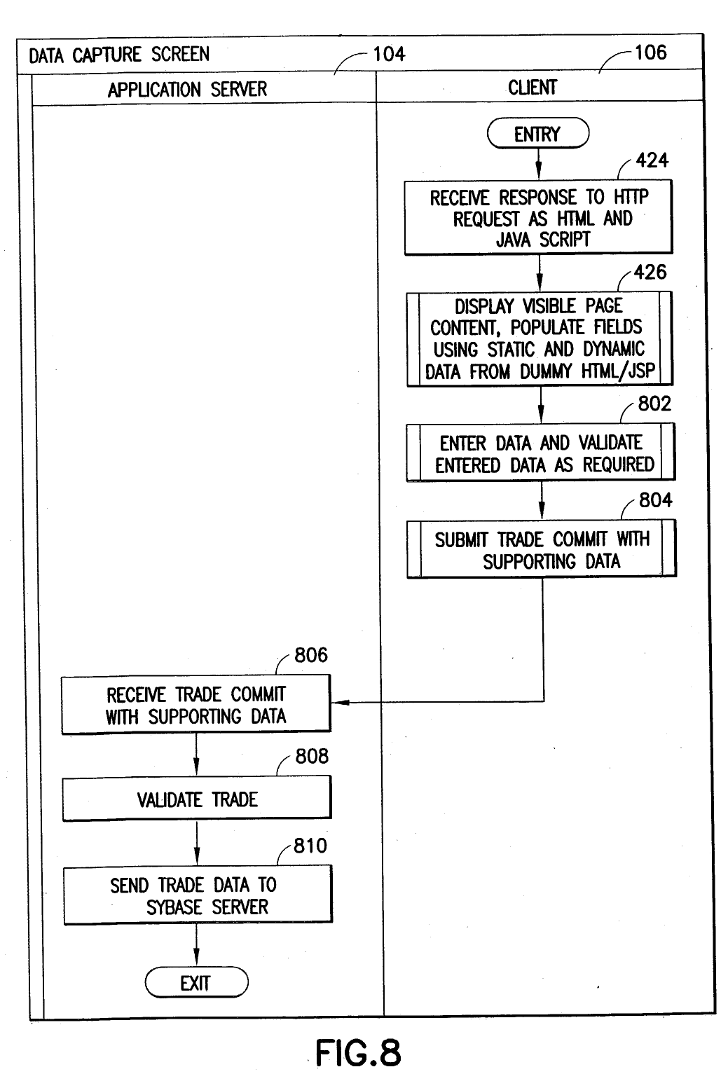

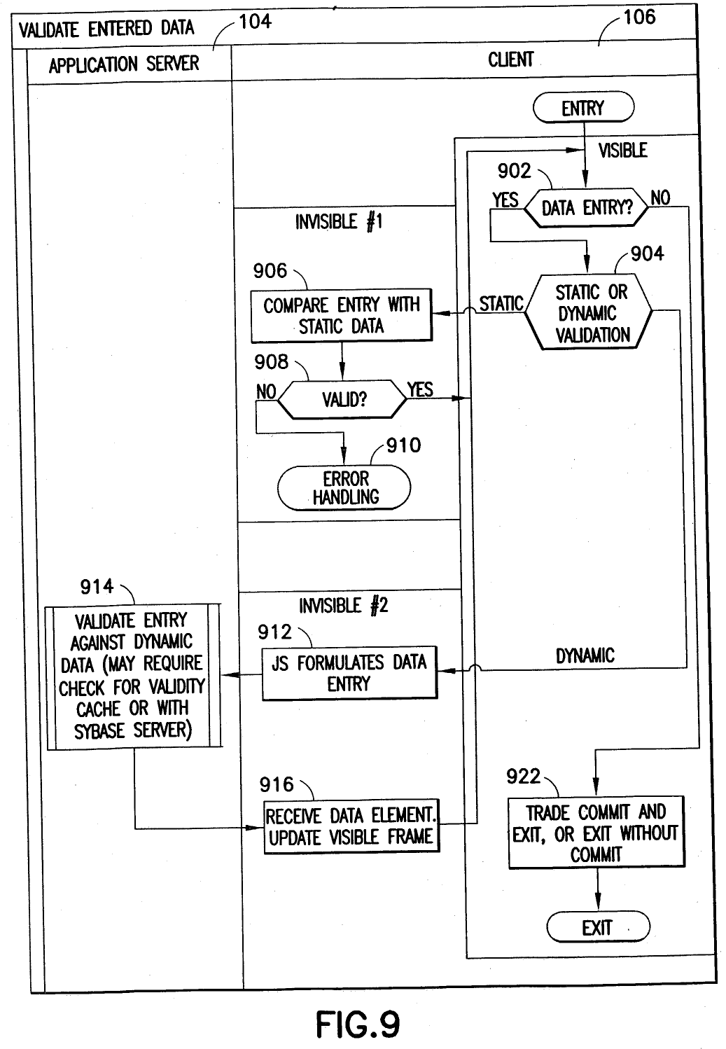

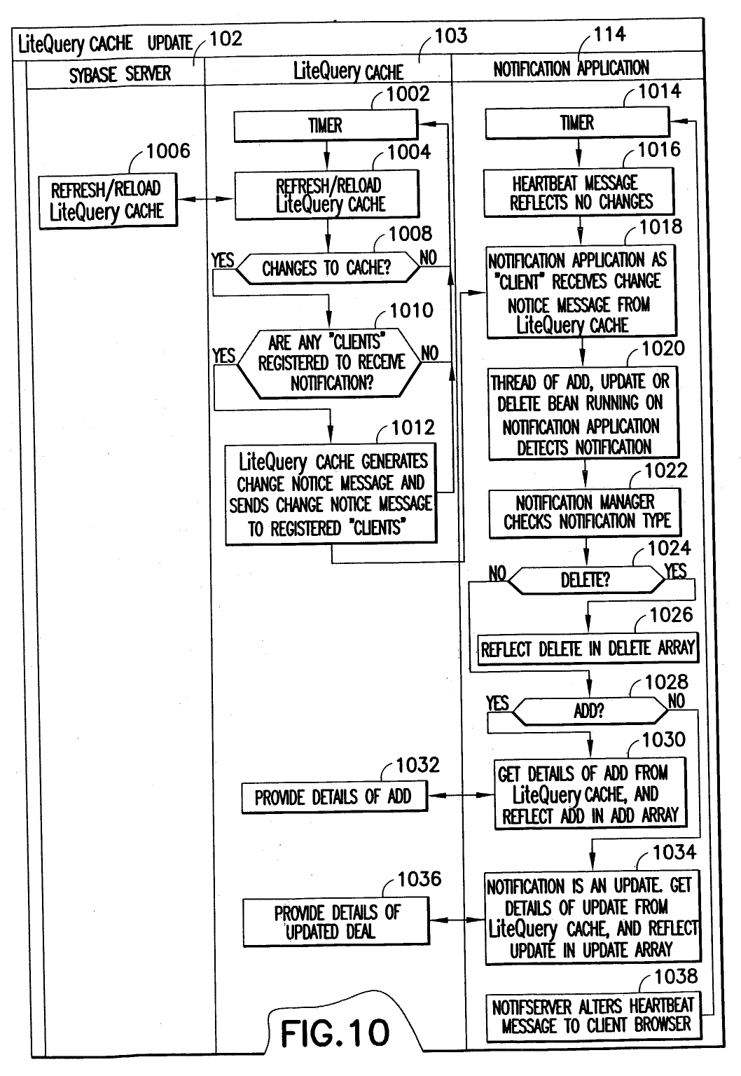

Referring now to FIG. 8, shortly after client browser 106 renders the display page (step 426), the user will begin to request further information and make trades using that information. At step 802, when the user enters or selects data on the display screen, some of the information is validated. Step 802 includes multiple steps, some of which are illustrated in FIG. 9.

At step 804, the user of client browser 106 submits a trade commit, which includes supporting data.

At step 806, application server 104 receives the trade commit with supporting data, and at step 808, validates the trade.

At step 810, application server 104 sends the trade data to Sybase server 102, where it is stored.

Referring now to FIG. 9, the steps for validation of data at step 802 of FIG. 8 are more fully described.

At step 902, client browser 106 determines whether the action is a data entry, as compared to a trade commit or exit without commit.

If the action is data entry, then at step 904, client browser 106 determines whether the entry requires validation against static data that is held by the respective invisible frame (204 of FIG. 2), or validation against dynamic data that is available through the respective invisible frame (202 of FIG. 2).

If static data, then at steps 906, 908, the data entry is compared or validated against static data. If the data entry is not valid, then at step 910, the user of client browser 106 is given an opportunity to correct the data entry and update the visible frame.

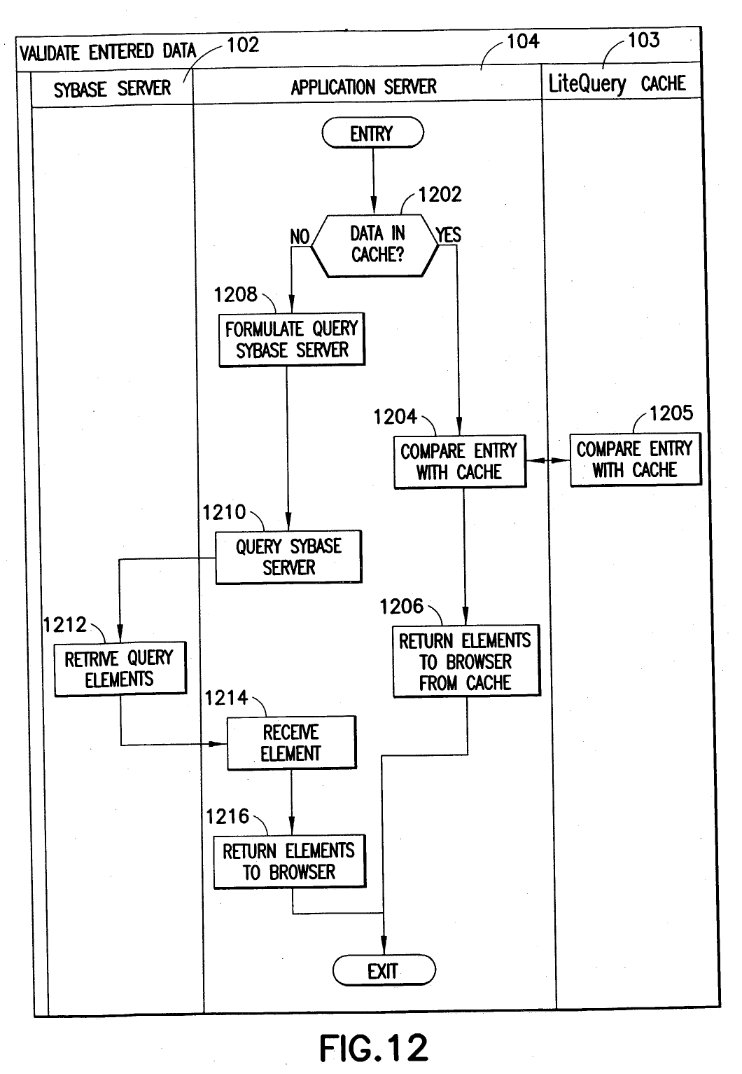

If at step 904, client browser 106 determines that the data entry requires validation against dynamic data, then at step 912, client browser 106 determines whether the data entry requires validation against dynamic data that is held by the respective invisible frame (202 of FIG. 2) or validation against data available from application server 104. Then at steps 914, 916, client browser 106 and application server 104 validate the entry and update the visible frame. The validation performed at step 914 includes multiple steps, which are illustrated in FIG. 12.

In addition to validation of dynamic data, it is possible to use the connection from the client to the application server and potentially to the Sybase server to assist with data selection. As an example, the user wants to select an asset and knows that the asset name begin with the letter B. When they enter the letter B into the field for asset and then press the enter key or tab out, JavaScript within the browser creates a query and passes that query to the application server with instructions to search the LiteQuery asset cache for all assets beginning with the letter B. For ease of description, this query is called a Memory filter LiteQuery. The application server is able to determine whether sufficient information is present within the LiteQuery asset cache to conduct the search, and if not formulates the search to access the Sybase database. The search result, which consists of all assets that begin with the letter B is then returned to the client browser and that set of assets that begin with the letter B is used to populate a pickbox on a layer of the visible frame of the browser.

In this way, the client browser 106 formulates a search and sends that search to the application server 104. The client browser 106 does not need to know how to conduct the search, only that the search is in assets and what the criteria is. The application server 104 knows how to conduct the search of the LiteQuery asset cache and also knows whether the type of information will be found in the LiteQuery asset cache, or whether the type of information must be found in Sybase database 108.

Another variation of validation is where data in two fields are related by a dynamic value. An example is where the denomination for a particular type of trade is in Argentine pesos, and another field on the trade blotter indicates the face amount in U.S. dollars. When the user enters the quantity in Argentine pesos, the JavaScript in the client browser 106 goes out to the application server 104, which may go to the Sybase server 102 if necessary, to retrieve the current foreign exchange rate. That rate is returned to the client 106 and the JavaScript uses that rate to calculate the face amount in U.S. dollars and then display that amount in the respective field of the trade blotter.

At step 922, client browser 106 determines whether the action is a trade commit and exit, or exit without commit.

In the steps illustrated in FIG. 9, the steps are described as checking for validity of entered data. However, it is also possible that instead of the user merely entering raw data that is then validated, the user is presented with choices for data selection. These various embodiments are described in greater detail below.

For example, in one data field, the user may be provided with a list box of countries. The countries are part of the static data that is stored in the respective invisible frame (204 of FIG. 2). That list of countries is used to populate the list box. Therefore, rather than “validate” the user entry of a particular country, the user is provided with a list box of valid countries to choose from. As long as the user's selection of a country comes from that list box, the entry will be valid. Therefore, in this embodiment, the range of possible data that might be entered is “validated” before the user selects it.

In another example, the range of possible security instruments is static data that is held within the respective invisible frame (204 of FIG. 2). The number of possible security instruments may be very large and use of a list box to display all of the instruments is not an ideal way to present the information. Therefore, the user of client browser 106 is provided with a blank data entry field, and as soon as they begin to type or enter data into the field, the possible security instruments that will match the data entry begins to narrow. As the user enters each character, the range of matching instruments is reduced until only one possible match is left, which the user selects. Alternatively, as the user enters characters, they are left with a smaller list of possible matching instruments, from which they select the desired instrument. This technique is different from the traditional list box technique of most existing browsers.

With the list box of existing client browsers, when the user types the first letter, the list box scrolls immediately to the first item in the list box that matches that letter. In order for the user to scroll down in the list box, they must either continue to enter the same letter or use the scroll bar. For example if the user wants to select the state of New York. The user enters the letter N, and the list box jumps/scrolls to Nebraska, which is the first state in an alphabetized list of states beginning with the letter N. As the user continues to press N, the list box scrolls one state each time. (ie., Nevada, New Hampshire, New Jersey, New Mexico, and finally New York). If the user does not continue to enter the same first letter (e.g., N), but instead enters the next letter in the name (e.g., E for the second letter of New) they are not taken to a state that has the first letters NE, but will be taken to Florida, the first state in the list box after E, certainly not what they wanted.

The validation described above involves checking entered data against static and dynamic data. Although not illustrated, the invention also uses other validation techniques, such as restricting data entry for certain fields to only certain types of data (e.g., numbers for amounts and allowable date format for dates). All of these validation checks are performed with JavaScript.

Referring now to FIG. 10, steps involving a refresh of LiteQuery cache 103 are illustrated.

At step 1002, a timer in LiteQuery cache 103 monitors the time since the last cache refresh, and upon expiration of the timer, at steps 1004 and 1006, refreshes or reloads LiteQuery cache 103 from Sybase server 102.

At step 1008, LiteQuery cache 103 and/or application server 104 determines whether there were changes to the cache. If no changes are identified in the cache, the process loops to step 1002 where the timer begins to monitor the time since the last cache refresh.

If a change is identified in the cache at step 1008, then at step 1010, LiteQuery cache 103 determines whether there are any “clients” registered to receive notification of the change. If no “clients” are registered, the process loops to step 1002 where the timer begins to monitor the time since the last cache refresh.

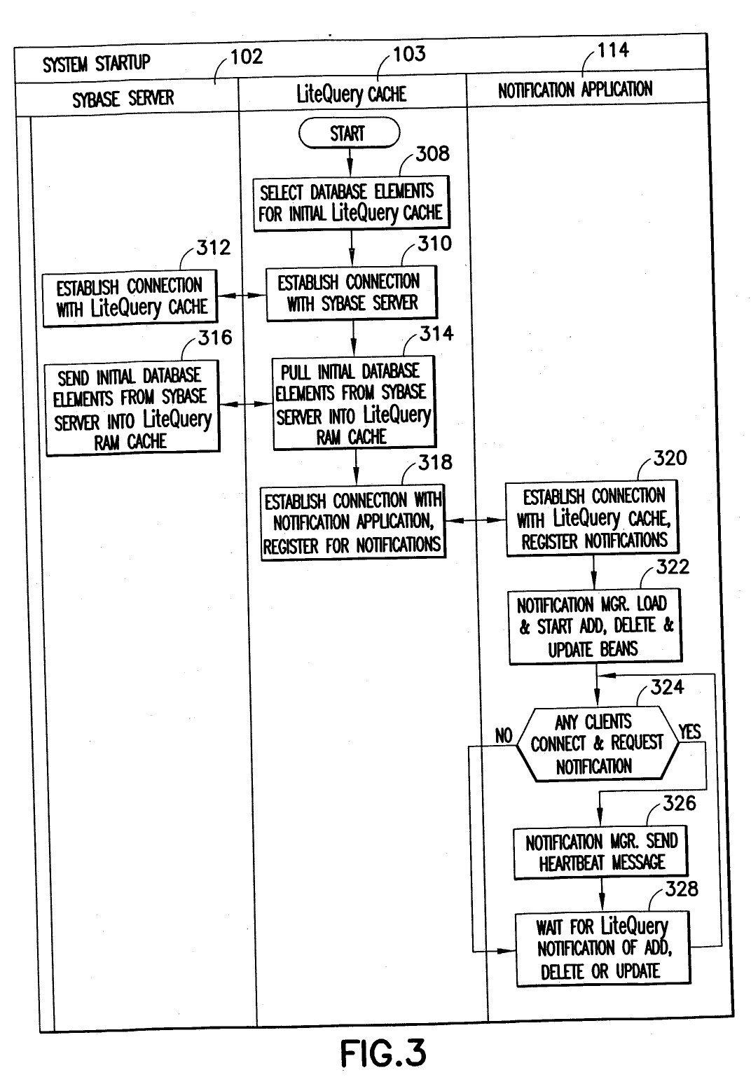

If there are “clients” registered to receive notification of the change, then at step 1012, LiteQuery cache 103 generates a change notice message and sends the change notice message to the registered “clients.” This indication of change includes the particular record ID that was added, deleted or updated. The “client” in this context is notification application 114. As discussed above, at steps 318, 320 of FIG. 3, notification application 114 registers with LiteQuery cache 103 for add, delete and update of certain database elements held in the cache. The registrations at step 318, 320 are what determines which “clients” are registered at step 101 0. The process running on LiteQuery cache 103 then loops to step 1002 where the timer begins to monitor the time since the last cache refresh.

During the time that LiteQuery cache 103 is periodically refreshing the cache and checking for changes in the cache data (steps 1002-101 2), notification application 114 also has a timer running at step 101 4, which controls transmission of a heartbeat message.

When the timer expires at step 101 4, notification application 114 sends a heartbeat message to client browser 106 over the TCP connection. Where there is no change notice message from LiteQuery cache 103, then at step 101 6, the heartbeat message reflects no change.

When notification application 114 receives a change notice message from LiteQuery cache 103 at step 101 8, then at step 1020, a thread of add, update and delete java beans running on notification application 114 detect the change notice message. The change notice message that LiteQuery cache 103 sends at step 101 2 typically includes identification of the cache element or record that changed, but does not include all of the particulars of the changed cache element or record. Therefore, where notification application 114 needs those particulars, the notification application uses the record ID to submit a request to LiteQuery cache 103 and retrieves the particulars for the record.

At step 1022, the notification manager checks for the type of change notification message. For example, the change notice may be add, delete or update.

At step 1024, the notification manager determines whether the change notice message is a delete, and if so, then at step 1026 delete of that data element is reflected in a delete array, which is held by application server 104. Although not illustrated, the process then moves to step 1038 and notification application 114 alters the heartbeat message to reflect change in a LiteQuery cache element and sends the “refresh” message to client browser 106.

Alternatively, at step 1028, if the notification manager determines that the change notice message is an add, then at steps 1030, 1032 notification application 114 or application server 104 gets information on the added data element from LiteQuery cache 103, and reflects the added deal or added data element in the add array, which is held by application server 104. Although not illustrated, the process then moves to step 1038 and notification application 104 alters the heartbeat message to reflect change in a LiteQuery cache element and sends the “refresh” message to client browser 106.

Finally, if the notification type was not add or delete, then at step 1034, notification manager determines that the change notice message is an update, and at step 1036 notification application 114 or application server 104 gets information on the updated data element from LiteQuery cache 103, and reflects the updated data element in the update array, which is held by application server 104. Although not illustrated, the process then moves to step 1038 and notification application 114 alters the heartbeat message to reflect change in a LiteQuery cache element and sends the “refresh” message to client browser 106.

At step 1038, there is a timer running within notification application 114 of application server 104. Every minute, a thread on each of the add, delete and update beans running in notification application 114 checks the respective arrays to determine, from the timestamp associated with each record, whether any of the changes reflected in the respective arrays are more than five (5) minutes old. If any of the changes in an array are more than 5 minutes old, that ID and associated information is removed from the array. This ensures that each array holds no more than 5 minutes of record changes. Sybase database 108 maintains a record of all records. The times used are fully configurable and may be longer or shorter than described.

Referring now to FIG. 11, steps involving the heartbeat message are illustrated. At step 1102, notification application 114 of application server 104 sends a heartbeat message to client browser 106. The heartbeat message is received over the TCP socket connection that was established at steps 428, 430 in FIG. 4. At a minimum, the heartbeat message reflects change or no change.

At step 1104, the applet in the hidden frame (202 of FIG. 2) running on client browser 106 receives the heartbeat message over the TCP socket connection. Within that applet is an instance variable that is set depending on what the heartbeat message says. The JavaScript polls the applet for the instance variable.

At step 1106, the JavaScript determines from the instance variable whether the heartbeat message reflects a change. In one embodiment, the heartbeat message becomes “refresh” to reflect the change. If the heartbeat message reflects no change, the JavaScript within the applet loops to step 1104 to continue monitoring the instance variable.

If the heartbeat message reflects a change, then at steps 11 08, 111 0, the JavaScript of client browser 106 causes client browser 106 to make an HTTP request to application server 104 to request the add, delete and update arrays, and in response, the client browser receives the respective arrays that have been added, deleted or updated within the last five (5) minutes. The added and updated arrays have complete information. The delete array has ID but no other information.

At step 1112, JavaScript running on client browser 106 begins a series of decisions and actions to process the respective arrays against the information held by client browser 106.

At step 1112, client browser 106 determines whether there are unprocessed records in the add array. If all records in the add array have been processed, then at step 1120, client browser 106 determines whether there are unprocessed records in the delete array.

If there is an unprocessed record in the add array, then at step 11 14, client browser 106 fetches that record.

At step 1116, client browser 106 uses the ID from the add array to determine if the record is reflected in the blotter.

If the record is in the blotter, then at step 1118, the blotter is updated from the add array.

If the record is not in the blotter, then at step 11 17, client browses 106 determines whether the record should be in the blotter. If the record should be in the blotter, the blotter is updated from the add array.

At step 111 2, client browser 106 again determines whether there is an unprocessed record in the add array.

If there are no more unprocessed records in the add array, then at step 1120, client browser 106 determines whether there are unprocessed records in the delete array. If all records in the delete array have been processed, then at step 1128, client browser 106 determines whether there are unprocessed records in the update array.

If there is an unprocessed record in the delete array, then at step 1122, client browser 106 fetches that record.

At step 1124, client browser 106 uses the ID from the delete array to determine if the record is reflected in the blotter.

If the record is in the blotter, then at step 1126, the blotter is updated from the delete array.

At step 1120, client browser 106 again determines whether there is an unprocessed record in the delete array.

If there are no more unprocessed records in the delete array, then at step 1128, client browser 106 determines whether there are unprocessed records in the update array. If all records in the update array have been processed, then at step 1104, client browser 106 monitors the heartbeat message at step 1104.

If there is an unprocessed record in the update array, then at step 1130, client browser 106 fetches that record.

At step 1132, client browser 106 uses the ID from the update array to determine if the record is reflected in the blotter.

If the record is in the blotter, then at step 1134, the blotter is updated from the update array.

At step 1128, client browser again determines whether there is an unprocessed record in the update array.

Referring now to FIG. 12, the validation performed at step 914 of FIG. 9 first checks at step 1202 to determine whether the data is in the cache.

If the data is in the cache, then at steps 1204, 1205 the entry is compared with the cache, and at step 1206 elements are returned to the browser from the cache.

If the data is not in the cache, then at step 1208, application server 104 formulates a query for Sybase server 102 and at step 1210, queries the Sybase server.

At step 1212, Sybase server 102 retrieves the query elements and sends the elements to application server 104.

At step 1214, application server 104 receives the elements and at step 1216 returns the elements to the browser.

Although illustrative embodiments have been described herein in detail, it should be noted and will be appreciated by those skilled in the art that numerous variations may be made within the scope of this invention without departing from the principle of this invention and without sacrificing its chief advantages. One such variation involves the separation of LiteQuery cache 103 from application server 104, so that they are not parts of the same server hardware.

The invention has been described with reference to illustrations of generally serial or synchronous transactions. However, it is understood that many of the transactions are not serial or synchronous, but are infact asynchronous. Therefore, one transaction may not occur until it is triggered by another transaction.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A method for updating information on a client computer, the method comprising:
creating a data cache as a subset of a larger database;
performing a periodic refresh of the data cache from the larger database;
identifying change in the data cache;
responsive to the change in the data cache, sending a message to the client; and
responsive to the message, automatically requesting the changed data.

2. A method according to claim 1, further comprising:
establishing a connection between the client and a server; and
responsive to a request from the client to the server, sending a set of data from the data cache to the client.

3. A method according to claim 2, wherein the connection uses HTTP protocol.

4. A method according to claim 1, further comprising:
establishing a connection between the client and a server; and
sending the message to the client from the server using the connection.

5. A method according to claim 4, wherein the connection uses TCP protocol.

6. A method according to claim 1, further comprising:
establishing a first connection between the client and a server;
establishing a second connection between the client and the server;
responsive to a request from the client to the server, sending a set of data from the data cache to the client over the first connection;
sending the message to the client from the server using the second connection; and
responsive to the message, automatically sending the request for the changed data from the client to the server using the first connection.

7. A method according to claim 1, wherein the message has at least two states, one state indicating no change in the data cache, and the other state indicating change in the data cache.

8. A method according to claim 7, wherein requesting the changed date is responsive to the message state indicating change in the data cache.

9. A method according to claim 1, wherein the message is periodic.

10. A method according to claim 1, wherein the message is aperiodic.

11. A method for notifying a client browser of a data change in a data cache, the method comprising:
creating a data cache in a RAM cache of an application server as a subset of a larger database;
establishing an HTTP connection between the client and the application server;
establishing a TCP connection between the client and the application server;
responsive to a resource request from the client, sending an html file via the HTTP connection to the client, the html file reflecting data in the data cache at a first time;
after the first time, performing a periodic refresh of the data cache from the larger database;
identifying change in the data cache;
responsive to the change in the data cache, sending a message from the application server to the client via the TCP connection; and
responsive to the message, sending a request for the changed data from the client to the application server via the HTTP connection.

12. Computer executable software code transmitted as an information signal, the code for updating information on a client computer, the code comprising:
code to create a data cache as a subset of a larger database;
code to perform a periodic refresh of the data cache from the larger database;
code to identify change in the data cache;
responsive to the change in the data cache, code to send a message to the client; and
responsive to the message, code to automatically request the changed data.

13. A computer readable medium having computer executable code stored thereon, the code for updating information on a client computer, the code comprising:
code to create a data cache as a subset of a larger database;
code to perform a periodic refresh of the data cache from the larger database;
code to identify change in the data cache;
responsive to the change in the data cache, code to send a message to the client; and
responsive to the message, code to automatically request the changed data.

14. A programmed computer for updating information on a client computer, comprising:
a memory having at least one region for storing computer executable program code; and
a processor for executing the program code stored in the memory, wherein the program code comprises:
code to create a data cache as a subset of a larger database;
code to perform a periodic refresh of the data cache from the larger database;
code to identify change in the data cache;
responsive to the change in the data cache, code to send a message to the client; and
responsive to the message, code to automatically request the changed data.
